(19) United States
(12) Patent Application Publication
(10) Pub. No.: US 2013/0319933 A1
(43) Pub. Date: Dec. 5, 2013

(54) Bioaugmentation using floating mixer

(71) Applicant: In-Pipe Technology Company, Inc., Wood Dale, IL (US)

(72) Inventors: John Williams, Wood Dale, IL (US); Richard Schici, Lombard, IL (US); Andrew Newbold, Norfolk, VA (US); Bulbul Ahmed, Aurora, IL (US)

(21) Appl. No.: 13/907,173

(22) Filed: May 31, 2013

Related U.S. Application Data
(60) Provisional application No. 61/654,429, filed on Jun. 1, 2012.

(51) Int. Cl. C02F 3/00

(52) U.S. Cl. CPC C02F 3/00
USPC 210/601; 210/198.1; 210/139

(57) ABSTRACT

The present invention is directed toward a device and method of dispensing biological solutions into a wastewater treatment system containing a floating mixer adapted to dispense biological solutions. The floating mixer with dispensing capabilities is strategically positioned within water holding areas, such as ponds or lagoons. The floating mixer and dispensing unit contain a flotation platform or other support structure, an impeller or similar device to create a flow pattern, and a dispensing device for controllably dispensing a microbial, preferably bacterial, solution.

### PRIORITY CLAIM

In accordance with 37 C.F.R. 1.76, a claim of priority is included in an Application Data Sheet filed concurrently herewith. Accordingly, the present invention claims priority under 35 U.S.C. §119(e), 120, 121, and/or 365(c) to U.S. Provisional Application No. 61/654,429 “BIOAUGMENTATION USING FLOATING MIXER”, filed Jun. 1, 2012. The contents of the above referenced application are incorporated herein by reference in its entirety.

### FIELD OF THE INVENTION

This invention relates to wastewater treatment; and more particularly, to a device and method for increasing bioaugmentation and/or bioaugmentation efficiency in a wastewater lagoon.

### BACKGROUND OF THE INVENTION

Treatment and disposal of wastewater is a major task for municipalities. In the early 20th century, municipalities began to adopt biological methods that now form the basis by which wastewater treatment plants function. Microorganisms act to catalyze the oxidation of biodegradable organics and other contaminants generating innocuous by-products such as carbon dioxide, water and biomass (sludge). In these systems, bacteria grow and divide, producing biosolids and clean water effluent. Today, this metabolism occurs in wastewater treatment plants which have the limits of size, retention time, processing capacity, and municipal budgets.

Technology exists, such as that described in U.S. Pat. Nos. 5,578,211 and 5,788,841, and is commercialized by In-Pipe Technology Company, Inc. (Wood Dale, Ill.) to effectively enhance the fundamental wastewater treatment process by starting treatment at strategic locations throughout the sewer collection system. Miles of sewer pipe are transferred into an active part of the wastewater treatment process, optimizing the entire infrastructure. This improves operating economics without additional capital expenditure. Since it uses natural, biological methods that work with the treatment plant's own processes, such technology is an environmentally and economically sound sustainable solution.

Based on the above listed patents, In-Pipe developed a process that consists of continual addition of high concentrations of select, facultative, symbiotic, spore-forming, naturally-occurring, non-pathogenic bacteria at multiple points located in the outer reaches of the wastewater collection system. The process enables bacteria to grow throughout the surface of the sewer pipes, thereby dominating the sewer biofilm with beneficial bacteria. This process improves the ability of the sewer biofilm to degrade the organic material. The process further provides the bacteria additional time to degrade the waste by taking advantage of the retention time of the wastewater within the sewer.

Lagoon systems have been utilized as part of the wastewater system for decades, as such systems are easy and cheap to establish. Similar to the sewer system, lagoons utilize biological treatment through the use of natural and energy-efficient processes to treat the wastewater stored within. While there are many different types of lagoon systems, i.e. anaerobic lagoons, aerobic lagoons, and facultative lagoons, all systems include one or more bodies of water designed to receive, hold, and treat wastewater for a predetermined time period. Wastewater stored within the lagoon undergoes a combination of physical, biological, and chemical treatments, thus providing a cost-effective means for wastewater treatment. While lagoon systems provide a cost effective method to treat relatively low wastewater volumes, the build-up of biosolids at the bottom of the lagoon impairs lagoon efficiency and is costly to remove.

Whichever system is utilized, wastewater lagoons act as a settling tank where wastewater solids settle resulting in well treated effluent. For wastewater treatment plants which use a lagoon as a part of the wastewater treatment process, bacteria directly enters the lagoon through the process wastewater. Due to the continuous addition of solids from the wastewater treatment plant and relatively longer dredging interval, microbes that are at the bottom layer do not reduce the biodegradable solids (i.e., anaerobic condition, limited mixing, and limited contact of incoming bacteria to dense layer of the solids) as effectively as those at the top layer. The development of an algal mat onto the water surface, as well as development of sludge layer/sludge-water-sludge, also limits the penetration into the water bodies. Wastewater bacteria entering the lagoon have limited functionality and may only enhance the degradation to a certain degree since these additions can only access part of the lagoon biosolids. Furthermore, the wastewater biosolid reduction is rapid and more effective under aerobic condition than anaerobic condition.

### SUMMARY OF THE INVENTION

The present invention is directed toward a device and method of dispensing biological solutions into a wastewater treatment system containing a mixer, preferably a floating mixer adapted to dispense biological solutions in order to increase bioaugmentation and/or bioaugmentation efficiency within a wastewater treatment system. The floating mixer with dispensing capabilities is strategically positioned within water holding areas, such as wastewater ponds or lagoons. The floating mixer and dispensing unit contains a flotation platform or other support structure, at least one mixing assembly having an impeller or similar device for increasing the pressure and flow of a fluid and to create a flow pattern, and a dispensing device for controllably dispensing a microbial, preferably bacterial, solution.

The device and method of dispensing biological solutions into a wastewater treatment system containing a floating mixer adapted to dispense biological solutions is adapted to enhance the destruction of biosolids in a lagoon through bioaugmentation of bacteria solutions simultaneously with a floating low energy mixer. The floating mixer with dispensing unit in accordance with the present invention functions to increase the availability of the biosolids, increase oxygen transfer, and increase contact between microbes and the biosolids. The floating mixer with dispensing unit enhances the biosolid degradation at a much faster rate due to the availability of oxygen, bioavailable food source and higher contact time. The mixer operation can be controlled to create anoxic condition to favor facultative microbial metabolisms by intermittent operation of the mixer.

In one embodiment of the invention, a method of treating a wastewater holding treatment site using mixer assisted bioaugmentation comprises the steps of: providing a wastewater holding treatment site; providing at least one a mixer adapted to disperse microbes, the mixer having at least one mixing assembly adapted for increasing the pressure and flow of a fluid, and at least one dispersing unit; placing the at least one mixer within the wastewater holding treatment site, the at least one mixer creating a fluid flow pattern within the wastewater holding treatment site; dispensing from the dispensing unit a microbial solution into the wastewater holding treatment site; and using the mixer assembly to deliver the dispensed microbial solution to one or more parts of the wastewater holding treatment site. The method provides for accelerating volatile solids reduction and decreasing the total volatile solids volume within the wastewater holding treatment site.

Accordingly, it is a primary objective of the present invention to teach a device and process to increase wastewater treatment within water holding reservoirs.

It is a further objective of the present invention to provide a device and process to increase wastewater treatment using a lagoon post water treatment plant or connected with a sewer/collection system.

It is yet an additional objective of the present invention to provide a device and process to increase wastewater treatment within a sewer/collection system using a lagoon which increases the availability of biosolids to further destruction through mixing within the lagoon.

It is a still further objective of the present invention to provide a device and process to increase wastewater treatment within a sewer/collection system using a lagoon which increases oxygen transfer within the lagoon.

It is a further objective of the present invention to provide a device and process to increase wastewater treatment within a sewer/collection system using a lagoon which increases the contact between microbes and the biosolids within the lagoon.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic diagram illustration of a bioaugmenting floating mixer with dispensing unit placed in a wastewater lagoon treatment system;

FIG. 2 is a schematic diagram illustration of a bioaugmenting floating mixer with dispensing unit secured to the bottom surface of the wastewater lagoon treatment system;

FIG. 3 is a schematic diagram illustration of the bioaugmenting floating mixer with dispensing unit placed in the wastewater lagoon treatment system shown in FIG. 2, illustrating initial dispersal of microbes into the flow pattern generated by the mixer;

FIG. 4 is a schematic diagram illustration of the bioaugmenting floating mixer with dispensing unit placed in the wastewater lagoon treatment system shown in FIG. 3, illustrating dispersal of microbes into the flow pattern generated by the mixer;

FIG. 5A illustrates a prior art flotation platform adapted to include a microbe dispensing unit;

FIG. 5B is an alternative embodiment of a low energy mixing unit;

FIG. 5C illustrates the low energy mixing unit illustrated in FIG. 5B in an aqueous environment and having a plurality of dispensing units attached thereto;

FIG. 5D illustrates the low energy mixing unit illustrated in FIG. 5B in an aqueous environment and having a plurality of alternative dispensing units attached thereto;

FIG. 6 is a block diagram of an illustrative embodiment of a microbe dispensing unit which can be coupled to a floating mixer and used to deliver a microbial consortium to the wastewater lagoon system;

FIG. 7 is a front perspective view of an alternative embodiment of a microbe dispensing unit which can be coupled to a floating mixer and used to deliver a microbial consortium to the wastewater lagoon system;

FIG. 8 is a rear perspective view of the alternative embodiment of the microbe dispensing unit which can be coupled to a floating mixer and used to deliver a microbial consortium to the wastewater lagoon system illustrated in FIG. 7;

FIG. 9 is a side perspective view of the alternative embodiment of the microbe dispensing unit illustrated in FIG. 7;

FIG. 10 is a perspective view of the alternative embodiment of the microbe dispensing unit illustrated in FIG. 7 with modules removed;

FIG. 11 is a perspective view of the alternative embodiment of the microbe dispensing unit illustrated in FIG. 7 with modules removed;

FIG. 12 is a right side perspective view of a removable module;

FIG. 13 is a bottom perspective view of the removable module shown in FIG. 12.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

In general, lagoon treatment is usually carried out by the indigenous bacteria present in the lagoon. Based on the age of the lagoon and poor metabolism of indigenous bacteria, sludge builds within and reduces the sludge holding volume. The device and methods in accordance with the present invention have been found to reduce the sludge volume through the destruction of volatile suspended solids. The present invention uses mixing plus bioaugmentation to accelerate the volatile suspended solids destruction process more efficiently than bioaugmentation alone, since it is believed that mixing plus bioaugmentation can enhance the contact between microbes and food, microbes can penetrate throughout the lagoon sludge depth, can improve oxygen transfer and can break the layer of sludge and make sludge uniform throughout the lagoon.

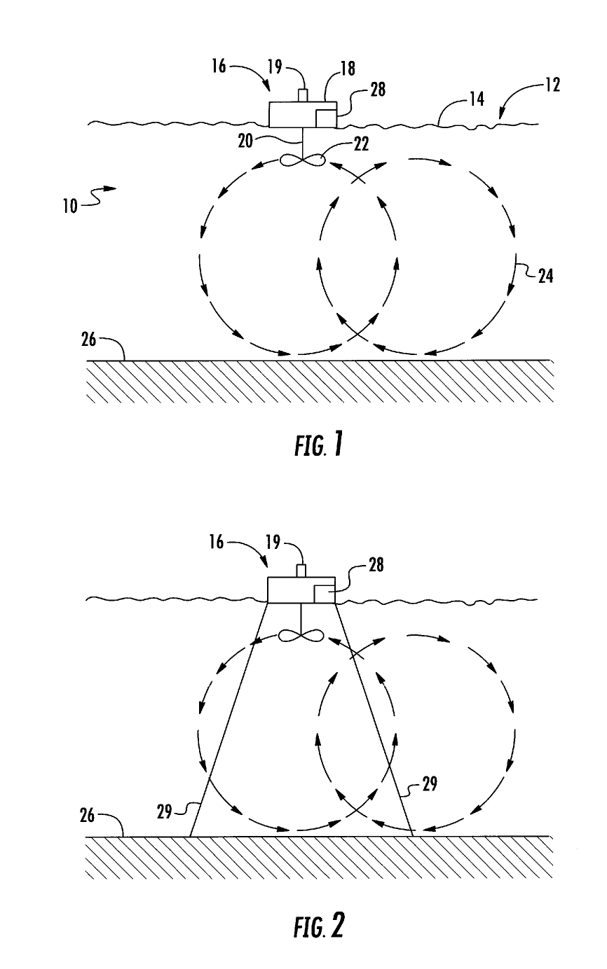

Referring to FIG. 1, a wastewater holding area, preferably a shallow holding area, illustrated herein as a wastewater treatment lagoon 10, storing wastewater 12 is shown. While the following description describes a device and method used in the wastewater lagoon, such description is not intended to be limited to a specific environment. Floating on the top surface 14 of the wastewater 12 is a floating mixer with dispensing unit, referred to generally as 16. In its simplest configuration, the floating mixer with dispensing unit 16 contains a main body 18, such as pontoon (i.e. an air filled structure providing buoyancy), which is constructed to maintain the floating mixer with dispensing unit 16 at the surface level 14. The device may contain internal components stored within or outside of the mixer to provide functionality. For example, the floating mixer 16 may contain a mixing assembly designed to increase the pressure and flow of a fluid which includes a power source (not illustrated, but could be external electrical or solar) for generating rotation of a geared motor 19. The geared motor 19 rotates a shaft 20 having an impeller 22 attached thereto along its terminal end. Rotation of the impeller 22 generates a flow pattern, see arrows 24, generated from pumping a jet of water directionally, i.e., vertically downwards in a manner similar to ceiling fans, using water instead of air, or pulling water upwards with the impeller. The floating mixer 16, however, can be designed to direct water flow in any direction so as to enhance the mixing in the lagoon. The flow pattern results in circulation along the upper surface 14, and bottom surface 26 and areas in between. While the floating mixer with dispensing unit 16 illustrated in FIG. 1 is designed to freely move about the lagoon 10, the device may be fixed in one place using securing cables 29 fixed to the bottom surface 26, see FIG. 2.

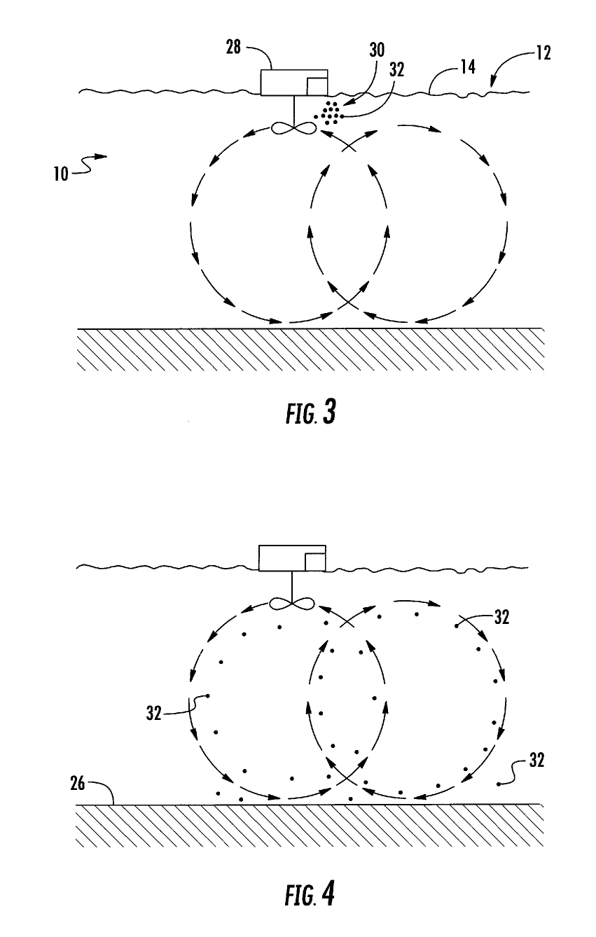

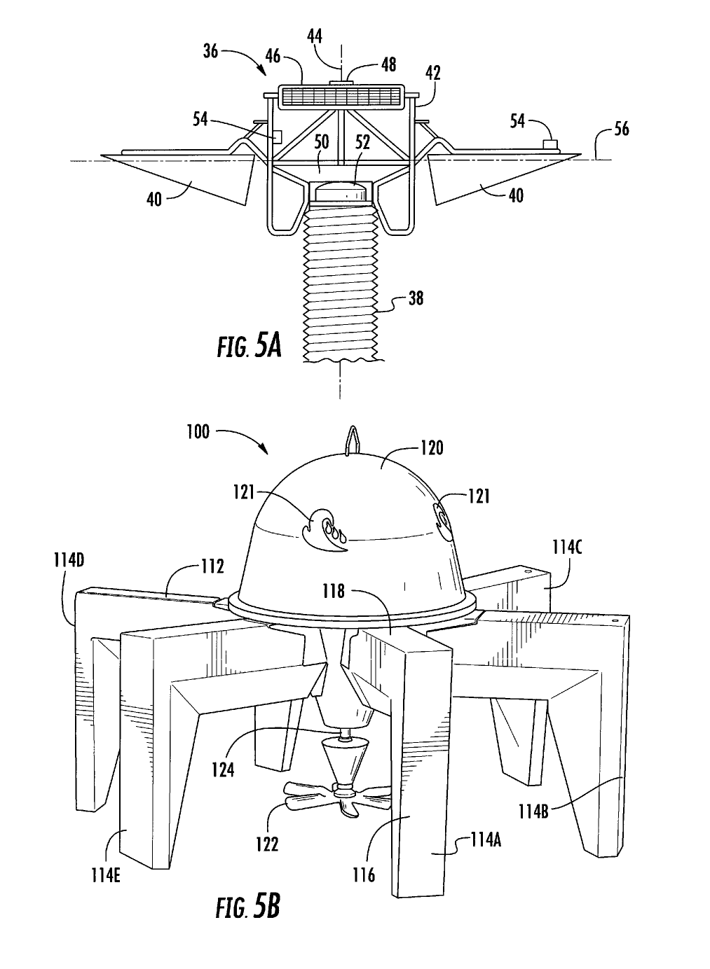

The floating mixer with dispensing unit 16 also contains a dispensing unit, referred to generally as 28. The dispensing unit 28 is constructed and arranged to deliver agents that provide for bioaugmentation. Preferably, the dispensing unit 28 is designed to dispense a consortium of microbes, such as a high concentration of select, facultative, symbiotic, spore-forming, naturally-occurring, non-pathogenic bacteria that play a role in wastewater processing. The consortium of microbes may be one or more species of bacteria selected to increase the efficiency of the wastewater treatment. FIG. 3 illustrates the dispensing unit 28 dispensing the consortium of microbes 30 into the wastewater 12. Once dispensed from the dispensing unit 28, the microbes 32 making up the consortium of microbes 30 are dispersed by the flow pattern, eventually settling to the bottom surface 26, see FIG. 4.

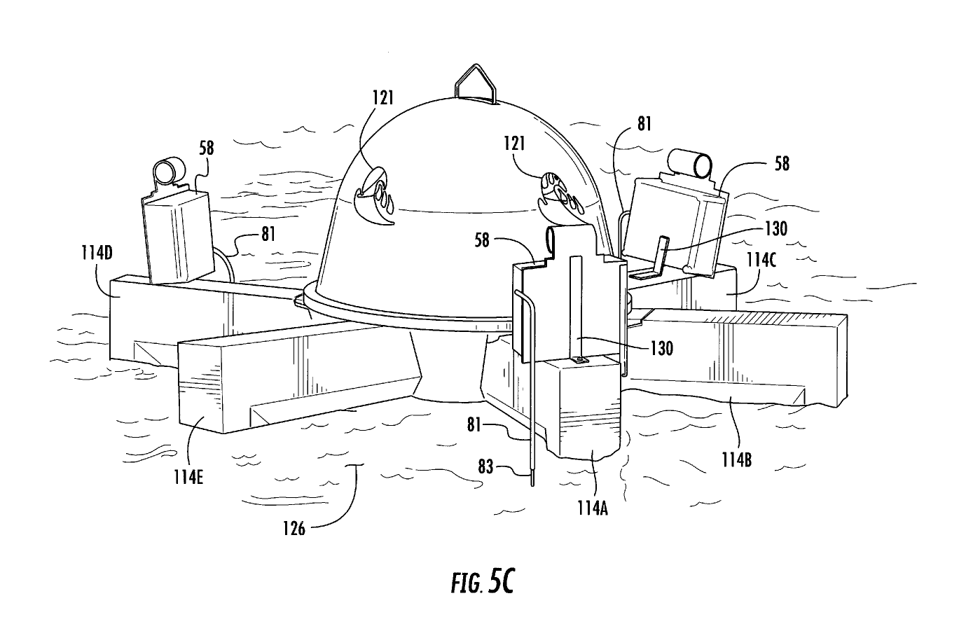

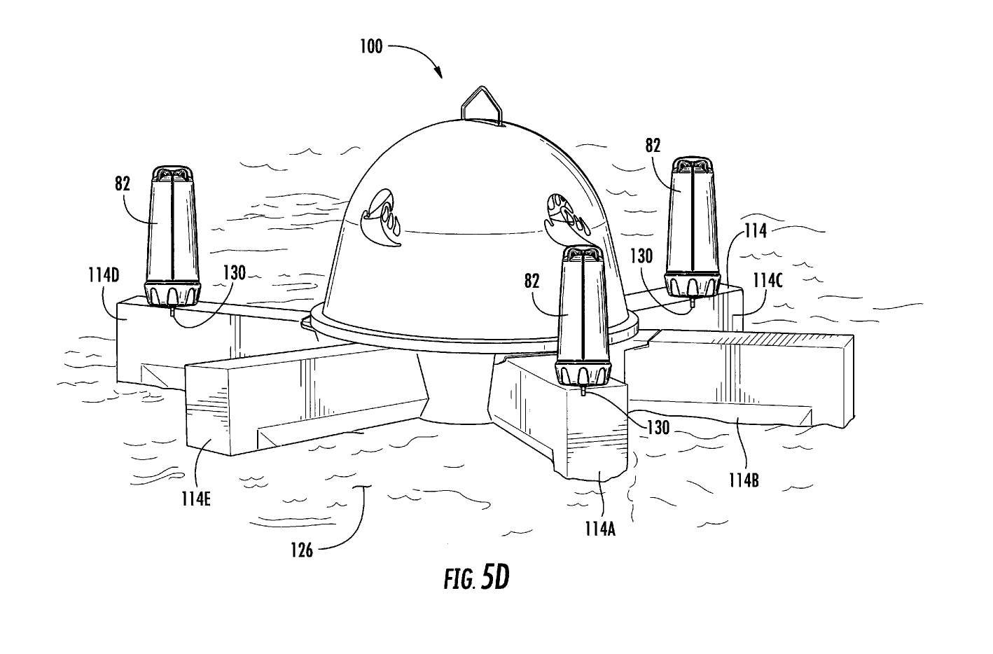

Numerous commercial low energy mixers are known in the art, and can be adapted to provide a floating mixer with dispensing unit 16 in accordance with the present invention. For example, several mixers useful in the wastewater environment are sold by SolarBee Inc., many of which are described and covered under U.S. Pat. Nos. 8,057,091; 7,906,017; 7,850,433; 7,798,784; 7,789,553; 7,670,044; 7,641,792; 7,517,460; 7,732,074; 7,306,719; and 7,285,208. FIG. 5A is a water circulator system covered under U.S. Pat. No. 8,057,091 which has been modified to include a dispensing unit. Referring to FIG. 5A, the circulator system includes an upper platform 36 with a draft hose 38 depending downwardly to a water inlet (not shown). The platform 36 comprises several floats 40 supported by a support frame 42. The floats are designed to extend outwardly from the center axis 44 to provide stability and buoyancy. The support frame 42 further contains solar panels 46, a driver, such as an electric motor 48, dish 50, and impeller 52. Attached to the support structure 36 are one or more microbe delivery units 54. While the delivery unit 54 is illustrated coupled to the support frame 42, delivery units 54 may be coupled to one or more floats, or other parts of the circulator system, either above the wastewater line 56, below the wastewater line 56, or combinations thereof.

FIG. 5B is an alternative low energy mixer referred to generally as 100. The low energy mixer 100 has a main support platform 112 with a plurality of legs 114A, 114B, 114C, 114D, and 114E, referred to collectively as 114 which act as floats. Each leg 114 is designed to have a lower portion 116 submergible within an aqueous environment and an upper portion 118 that remains above a water line. A housing unit, illustrated herein as a domed structure 120 having cutout vents 121 houses the internal components, such as a FTW Euro Drive Motor 440 volts, that drive impeller 122 coupled to shaft 124. The low energy mixer 100 is designed to provide high efficiency mixing at minimal costs, with an estimated power use is estimated at 816 kilowatt hours per month. The mixing diameter is preferably designed to be 10 times the available depth of the lagoon and moves water vertically, but the majority of movement is laterally due to the design of the impeller and orientation of flow. The low energy mixer 100 has no bearings in the water and runs at low rpm's (125 rpm). The low energy mixer 100 is preferably run constantly with the FTW Euro Drive Motor (440 volts) at for example 1.5 HP. The low energy mixer 100 may be powered using a 12-gauge SO cord (4-lead wire, UV, water resistant) with a power source supplied by a building near the lagoon. Alternative means of powering the unit known to one of skill in the art may be used, including for example solar power.

FIG. 5C illustrates the low energy mixer 100 within an aqueous environment, i.e. a lagoon system 126, having a plurality of delivery units 58 (delivery unit 58 described below). Each delivery unit 58 can be secured to one or more legs 114 using for example bracket 130. FIG. 5D illustrates the low energy mixer 100 within the lagoon system 126 and having a plurality of delivery units 82 (delivery unit 82 described below) secured thereto.

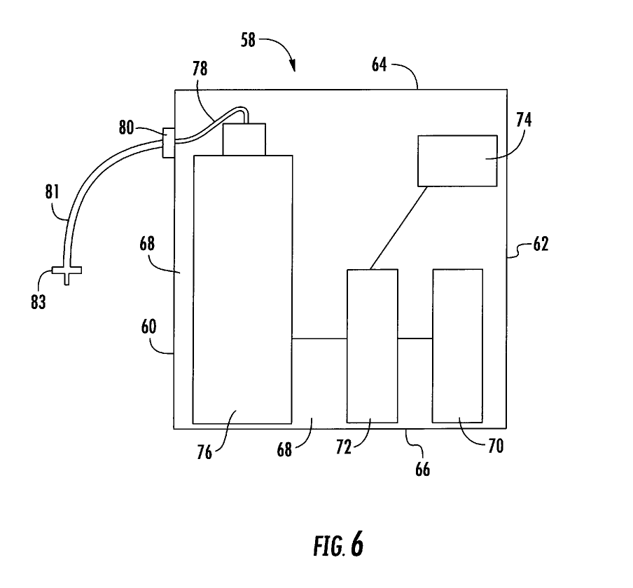

Referring to FIG. 6, an illustrative embodiment of a delivery unit, illustrated herein as microbial dosing panel 58 is shown. The delivery unit 58 is preferably placed somewhere along the floating mixer as described and/or illustrated previously. The delivery unit 58 contains a panel containing side walls 60 and 62 arranged in parallel fashion, and walls 64 and 66 arranged in parallel fashion. The delivery unit 58 also contains a back wall 44 and a front wall, removed to illustrate the internal components. Walls 60, 62, 64, 66 and the front wall interconnect to form an enclosed interior portion 68. The interior portion 68 contains the working elements of the delivery unit 58. The delivery unit 58 is powered by a power source, illustrated herein as a battery pack 70. A pump 72, illustrated herein as a solenoid pulse pump, is operated by a small circuit board 74. A. The delivery unit 58 holds a source of microbes which is stored in a reservoir 76 and dispensed through tubing 78 to the outside through opening 80. External delivery tubing 81 having a nozzle 83 may be used to help dispense the microbial consortium in a directed manner. In order to repopulate the lagoon 10, the delivery unit 58 can be configured to continually deliver a pre-determined amount of the microbial consortium over a period of time. The delivery unit is preferably delivered as a single unit so that when the microbial solution is empty, the entire unit 58 is replaced by a new unit 58.

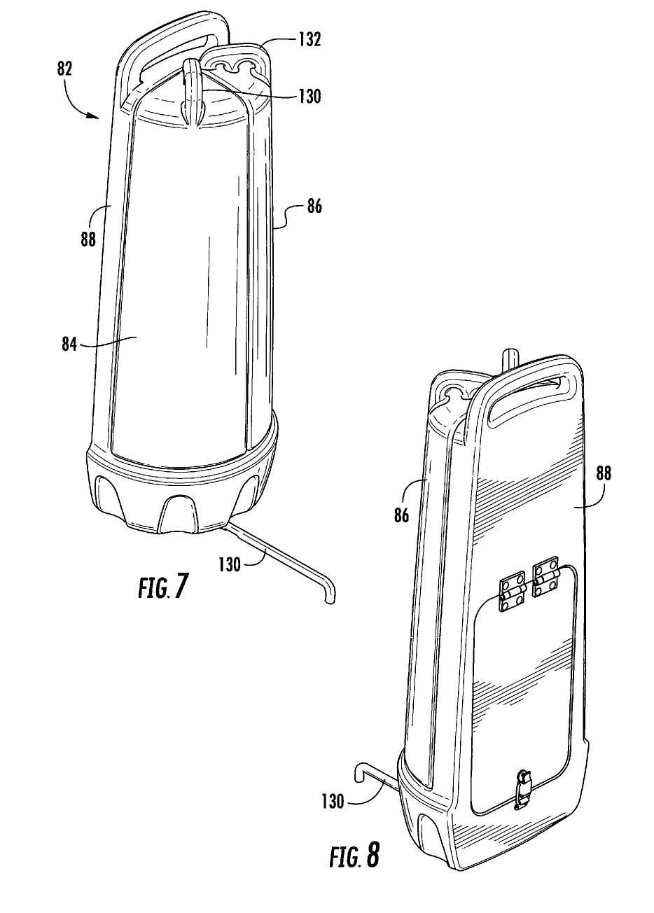

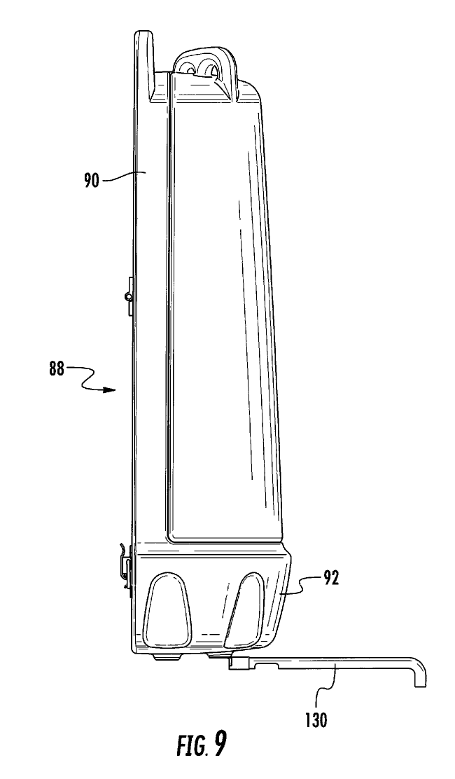

Referring to FIGS. 7-9, an alternative embodiment of a delivery unit 82, referred to generally as a modular smart biofeeder 82, is shown. The delivery unit 82 is fully described in U.S. patent application Ser. No. 13/739,916, entitled “A Modular Smart Biofeeding Device” the content of which is herein incorporated by reference in its entirety. The modular smart biofeeder 82 differs from delivery unit 58 in that the modular smart biofeeder 82 is designed as a modular device having removable compartments. For example, once the microbe solution is empty, only the bags and/or the unit storing the microbe solution would require replacement. The modular smart biofeeder remains secured to the floating mixer. The modular smart biofeeder 82 contains one or more removable compartments, illustrated as removable modules 84 and 86, coupled to a main dispensing unit body 88. The main dispensing unit body 88 comprises a vertical support structure 90 and a base 92, see FIG. 9.

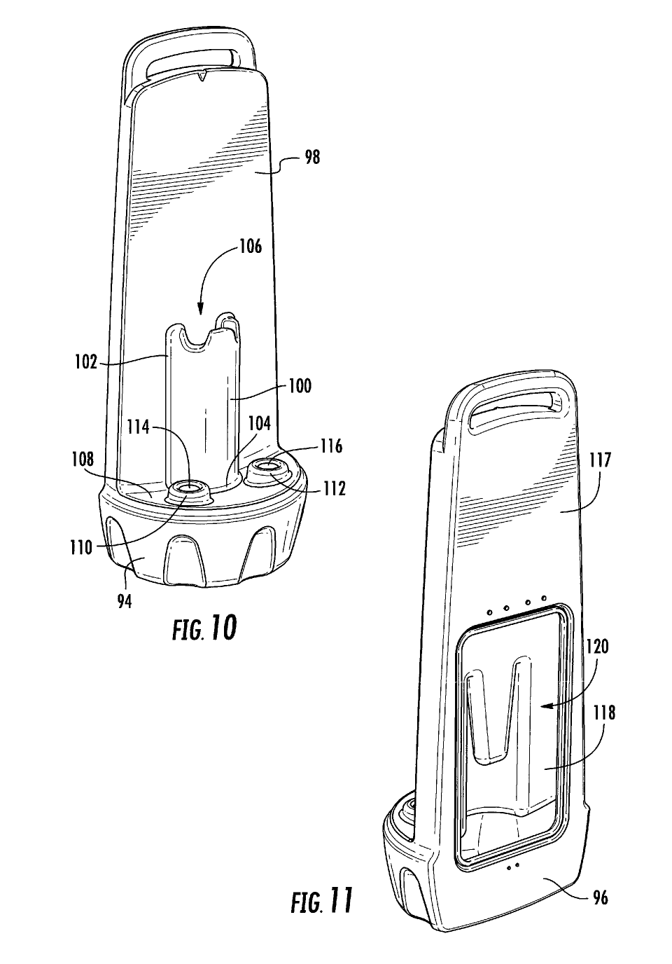

The one or more removable modules 84 and 86 are constructed and arranged to be securable to the support structure 90 and the base 92. Each module is preferably made of a durable plastic material. Referring to FIGS. 10-13, the modular smart biofeeder 82 is illustrated with the removable modules 84 and 86 detached from the main dispensing unit body 88.

The base 92 contains a partially cylindrical portion 94 and a planer portion 96, see FIGS. 10 and 11. The interior surface 98 of the support structure 90 is generally planer and allows for a portion of the modules 84 and 86 to abut and rest flush with the support structure 90. The interior surface 98 contains a first module securing member, illustrated herein as a partially cylindrical structure 100. The partially cylindrical structure 100 contains a first end 102 and a second end 104. The first end 102 contains opening 106 which exposes an interior cavity therein. The second end 104 is closed and rests on the upper surface 108 of the base 92 at or near where the support structure 90 intersects with the base portion 92. The length and width of the partially cylindrical structure 100 is preferably sized and shaped to accommodate a portion of the removable module 84 or 86 to prevent lateral, or side-to-side, movement of the modules away from or off the main unit body 88.

Positioned on the upper surface 108 of the base 92 is a second module securing member, illustrated herein as cylindrically shaped plug members 110 and 112. Each of the plug members 110 and 112 is constructed and arranged to provide secured mating with a portion of the removable modules 84 and 86. The plug members 110 and 112 may be solid, or alternatively may contain an opening 114 which exposes an internal cavity. The plug members 110 and 112 may contain a rimmed or lipped outer surface 116 to provide a friction or snap fit connection to secure the removable module 84 and 86 to the base 92, thereby preventing both lateral movement and horizontal movement. The rimmed or lipped outer surface 116 is constructed and arranged to prevent the modules from upward and/or side-to-side movement while allowing the modules to be detached under a sufficient predetermined force.

The back surface 117 of the main dispensing unit body contains opening 118 which exposes an interior compartment 120. The interior compartment 120 is constructed and arranged to hold a variety of hardware to provide the device with fluid dispensing functionality, including a pump for dispensing microbial solutions, a control unit such as a microcomputer, and a power source. Microbial solutions are preferably dispensed using onboard circuitry and timers to deliver loads at a designated rate and at designated times. Dispensing of the microbial solutions can be programmed on board or remotely using a remote unit having a receiver and/or transmitter to send information through a wireless link such as Bluetooth or cellular phone communication technology to a receiving and/or transmitting device in communication with the microcomputer. Pressure sensors may also be included to) to detect the weight of the solution as well as variations in pressure when the fluid is pumping to determine working status of the pump or low levels of microbial solutions.

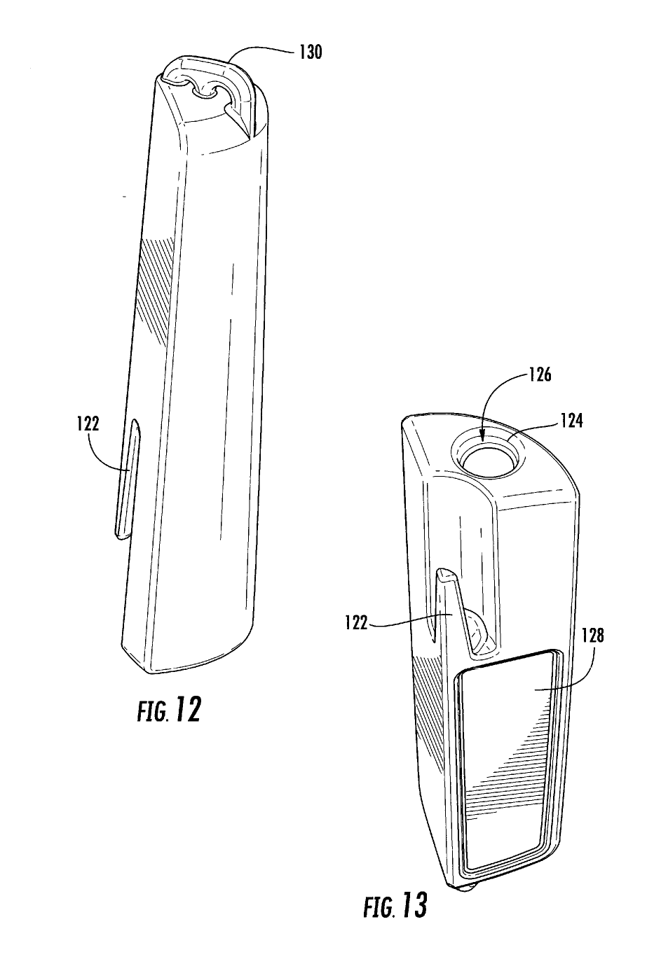

Referring to FIGS. 12-13, the removable module 84 is shown. Both of the removable modules 84 and 86 are preferably constructed and arranged in the same way. Accordingly, only the removable module 84 is described in detail. The removable module 84 contains a finger-like protrusion 122 constructed and arranged to be coupleable to the first removable module securing member cylindrical structure 100. To secure the removable module 84 to the main dispensing unit body 88, the finger-like extension 122 is inserted into the opening 106 of the first end 102 of the cylindrical structure 100, resting within the interior cavity. The removable module 84 also contains a module securing member receiving element 124. The module securing member receiving element 124, illustrated herein as a circular receptacle containing an opening 126 is sized and shaped to receive plug members 110 or 112. The module securing member receiving element 124 may be stepped to provide a better securing means.

The removable module 84 may contain at least one internal compartment 128 which is constructed and arranged to hold one or more objects. Preferably, the internal compartment 128 contains a bag, similar to a plastic medical style intravenous bag, which contains a solution, such as a microbial solution of one or more bacteria species, to be dispensed. The at least one internal compartment 128 may contain a window, made of glass or clear plastic to provide visualization of the contents within.

The modular smart biofeeder 82 functions primarily to dispense predetermined amounts of the bacteria solution into a precise location within the lagoon 10 at predetermined times using dispensing tube 130. The bacteria solution stored within the removable modules 84 or 86 (either directly or stored within a removable bag) is fluidly connected to a dispensing device, such as a pump and dispensed to the lagoon via the dispensing tube 130. The dispensing device may be controlled by the onboard microcomputer to dispense the bacterial solution at a designated rate and at designated times. Dispensing of the bacterial solution can be programmed on board or remotely using a remote unit having a receiver and/or transmitter to send information through a wireless link such as Bluetooth or cellular phone communication technology to a receiving and/or transmitting device in communication with the microcomputer. A pressure sensor may be used to detect the weight of the solution within the modules 84 or 86 as well as variations in pressure when the fluid is pumping. Using static pressure, the amount of fluid remaining in the bag can be detected and monitored.

The biofeeder device 10 is preferably powered using rechargeable batteries (not illustrated) generating 12V to drive the pump. The battery voltage is monitored by an A/D input on the microcomputer. Battery level indicators (not illustrated) are included to visually indicate if proper charge on the battery remains. Real time monitoring of the battery life can be kept through the use of a RTCIC. If the battery or the biological solution must be replaced, the user retrieves the removable module 84 or 86 from the base 90 by inserting a retrieving device such as a hook, within handles 132, see FIG. 7, and lifting in an upward direction. The batteries or fluid containers are replaced and the modules 84 or 86 are lowered back into the correct, secured position onto the base 92.

Once attached to the floating mixer, the dispensing units allow for the floating mixer to move around within the lagoon environment, i.e. free float, or can be fixed in one place. In either use, a continuous or predetermined distribution of the microbial solution can therefore be placed within the lagoon environment concurrently with the mixing assembly creating a flow pattern. Such action allows for the microbial solution to 1) be dispersed in a flow pattern generated by the mixing assembly and/or 2) can be in contact with any material, i.e. sludge/solids released from the bottom as a result of disturbance resulting from the flow pattern.

While lagoon wastewater treatment systems provide significant benefits, lagoon treatment processes are less efficient in cold weather, ineffective at removing heavy metals, and often run into problems associated with nuisance odor and algae blooms. Therefore, proper maintenance and operation is essential for the bacteriological mechanisms to provide efficient wastewater treatment. The present invention, systems and methods provide a mechanism for improving the use of lagoon wastewater systems by reducing the economic burden of sludge disposal by degrading the volatile suspended solids present in the sludge within the lagoon and restoring the microbiological activity in the lagoon so that municipalities using such lagoon system could operate lagoon wastewater treatment efficiently without dredging the lagoon while meeting the effluent discharge limits.

The present invention, systems, and methods were used to improve the functioning of a city located in the Midwest, referred to as City using a lagoon system. The city has used the lagoon system to treat wastewater for over 40 years. The lagoon was near capacity with approximately 91,000 cubic yards (CY) of sludge (17.8% volatile solids) which was believed to be due in part to ineffective microbiological activity. Upon analysis, the sludge blanket contained layers of silt and sludge, which was very thick and experiencing accelerated algae growth. These factors contributed to effluent suspended solids violations and required corrective action. The City planed to dredge the lagoon. However, removing the large sludge volume was cost prohibitive. The present device, systems, and/or methods were used as alternative methods to reduce the lagoon sludge, thereby reducing the economic burden of sludge disposal and restored the microbiological activity in the lagoon. In order to achieve such results, the lagoon system was treated for a period of 180 days to accelerate volatile solids reduction and decrease the total volatile solids volume by a minimum of 25%. As such, a highly concentrated formulation of robust and sustainable facultative bacteria was added to the lagoon system using a low energy mixer, such as low energy mixer 100, to accelerate volatile solids reduction. The main goal using the low energy mixer 100 to disperse microbes was to reduce the economic burden of sludge disposal by degrading the volatile suspended solids present in the sludge. An additional objective was to restore the microbiological activity in the lagoon so that city could operate lagoon wastewater treatment efficiently without dredging the lagoon while meeting the effluent discharge limits.

Lagoon characteristics: The City wastewater treatment lagoon receives primary clarifier effluent (approximately 0.97 MGD) with approximately 100 mg/L of biochemical oxygen demand (BOD₅) and approximately 100 mg/L of total suspended solid (TSS). The lagoon is aerated with coarse bubble diffused air headers spaced 100 feet apart throughout the entire lagoon. The effluent BOD₅ and TSS discharge limit is 25 mg/L and 30 mg/L, respectively. The 14 acre lagoon is 1,200 ft long and almost 600 ft wide with a design depth of 10 ft. The current sludge depth averages 4 ft.

Since the lagoon wastewater treatment system is over years old and had different strata of silt/sludge, a low energy (1.5 HP) floating mixer 100, with microbial dosing panels or modular smart biofeeder 82 was added to the lagoon to break the strata, mix the densely packed sludge, promote oxygen transfer, and to promote contact between food and microbes. The low energy (1.5 HP) floating mixer provides a mixing radius of ten times the available depth, which is approximately 100 ft in diameter at the City lagoon. During the treatment process, three automatic microbial dosing panels on the top of the floating mixer or three modular smart biofeeders 82 were installed, see FIG. 5C or 5D. These automatic dosing panels were programmed to continuously dispense microbial formulation while mixing occurred. The low energy floating mixer was moved within the lagoon in accordance with an engineered plan at 200 ft increments to cycle twice around the lagoon in 180 days. Additionally, six panels/modular smart biofeeders were added at the entrance of the lagoon wastewater treatment system to inoculate the lagoon influent with a high concentration formulation of robust and sustainable facultative bacteria. Bacteria and mixing was conducted continuously from project inception.

Laboratory biochemical analysis of 8 point grid lagoon samples (% volatile solid/total solid (VS/TS), pH and NH₃ concentration) were carried out by an independent contractor, Test Inc., (www.testinc.com). The sludge blanket was too thick to measure using a sludge judge, so McClure Engineering (Engineering Consultant to the City) created a topographic map of the sludge blanket using an adapted approach. In this method, a PVC disk (¼ inch thick and 8-12 inch in diameter, specific gravity 1.4) sinks through the liquid and settles at the water-sludge interface and measures the depth from the liquid surface to the top of the sludge layer. Sludge depth was calculated from the known depth from the liquid surface to the lagoon bottom. Each location was plotted using GPS and the sludge measurements were carried out at 50 ft increments (creating a 50×50 grid). The average sludge layer depth was used in the sludge volume calculation.

A “Pre-treatment” analysis completed was used as a baseline to compare with bioaugmentation treatment performance. Bioaugmentation treatment performance evaluations were carried out at the end of 180 day treatment cycle.

Performance evaluation at the end of 180 day low energy mixer assisted bioaugmentation treatment indicated that the volatile solids content was reduced by approximately 25% from 16,208 CY to 12,208 CY, see Table 1. The decrease in volatile solids content was believed to be the result of enhanced contact between organics and microbes, the metabolism of the bacteria forming the dispensed microbial solution (e.g., organic consumption rate, growth rate), and hydrolysis and solubilization of the complex, less biodegradable and slowly hydrolysable organics. The pH with treatment (pH 7.53) did not change significantly compared to the baseline pH of 7.05. The increase in NH₃ oxidation [approximately 9% reduction (1,691 mg NH₃/kg TS to 1540 mg NH₃/kg TS)] indicated the restoration of the bacteriological activity (e.g., autotrophic and heterotrophic nitrification) with the bioaugmentation treatment.

TABLE 1
Sludge inventory during Pre-treatment
and with bioaugmentation treatment:

| | | Bioaugmentation |
|---|---|---|
| Period | Pre-Treatment | Treatment |
| Sludge Volume | 91,057 CY (cubic | 75,820 CY |
| | yards) | |
| Volatile Solids | 17.8% | 16.1% |
| Total Volatile | 16,208 CY | 12,208 CY |
| Solids | | |

| | |
|---|---|
| Total volatile | 4000 CY |
| removed (with | |
| treatment vs. pre- | |
| treatment ) | |
| % volatile solids | 24.7% |
| reduction | |

Bioaugmentation treatment using low energy mixers adapted to disperse microbes successfully reduced approximately 25% of the volatile solids in 180 days of treatment application and reduced the City's economic burden of sludge disposal. Additionally the bioaugmentation treatment restored the microbiological activity thereby enabling the City to operate the lagoon wastewater treatment efficiently for longer periods without dredging the lagoon and while meeting the effluent discharge limit. The innovative low energy mixer assisted bioaugmentation treatment enhanced contact between bacteria and organics, improved wastewater treatment performance, and may replace traditional aeration processes.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A device for bioaugmentation in a wastewater treatment site comprising a floating mixer adapted to disperse microbes, said mixer having at least one mixing assembly adapted for increasing the pressure and flow of a fluid, and at least one dispensing unit.

2. The device for bioaugmentation in a wastewater treatment site according to claim 1 wherein said at least one dispensing unit is adapted to dispense at least one microbial solution.

3. The device for bioaugmentation in a wastewater treatment site according to claim 2 wherein said microbial solution includes facultative, symbiotic, spore-forming, naturally-occurring, non-pathogenic bacteria that play a role in wastewater processing.

4. The device for bioaugmentation in a wastewater treatment site according to claim 1 further including at least one securing cable for fixed attachment to the bottom surface of a wastewater treatment site.

5. The device for bioaugmentation in a wastewater treatment site according to claim 1 wherein said dispensing unit is a microbial dosing panel.

6. The device for bioaugmentation in a wastewater treatment site according to claim 1 wherein said dispensing unit is a smart biofeeder adapted to dispense predetermined amounts of a microbial solution into a precise location within said wastewater treatment site at predetermined times.

7. The device for bioaugmentation in a wastewater treatment site according to claim 1 wherein said dispensing unit is a smart biofeeder adapted to continuously dispense predetermined amounts of the microbial solution into a precise location within the wastewater treatment site.

8. The device for bioaugmentation in a wastewater treatment site according to claim 1 wherein said dispensing unit is a smart biofeeder having one or more removable modules.

9. A method of accelerating volatile solids reduction and decreasing the total volatile solids volume within a wastewater holding treatment site using mixer assisted bioaugmentation comprising the steps of:
providing a wastewater holding treatment site;
providing at least one mixer adapted to disperse microbes, said mixer having at least one mixing assembly adapted for increasing the pressure and flow of a fluid, and at least one dispersing unit;
placing said at least one mixer within said wastewater holding treatment site, said at least one mixer creating a fluid flow pattern within said wastewater holding treatment site;
dispersing from said dispensing unit a microbial solution into said wastewater holding treatment site; and
using said mixer assembly to deliver said dispensed microbial solution to one or more parts of said wastewater holding treatment site.

10. The method of accelerating volatile solids reduction and decreasing the total volatile solids volume within a wastewater holding treatment site using mixer assisted bioaugmentation according to claim 9 further comprising the steps of
providing at least one dispersing unit at the entrance of said wastewater holding treatment site; and
inoculating the lagoon influent with a microbial solution dispensed from said at least one dispersing unit at the entrance of said wastewater holding treatment site.

11. The method of accelerating volatile solids reduction and decreasing the total volatile solids volume within a wastewater holding treatment site using mixer assisted bioaugmentation according to claim 9 further including the step a continuously dispensing said microbial formulation while mixing occurs.

12. The method of accelerating volatile solids reduction and decreasing the total volatile solids volume within a wastewater holding treatment site using mixer assisted bioaugmentation according to claim 9 wherein said floating mixer is moved within said wastewater holding treatment site at a predetermined rate.

13. The method of accelerating volatile solids reduction and decreasing the total volatile solids volume within a wastewater holding treatment site using mixer assisted bioaugmentation according to claim 9 wherein said floating mixer is fixed at one location within said wastewater holding treatment site.

14. The method of accelerating volatile solids reduction and decreasing the total volatile solids volume within a wastewater holding treatment site using mixer assisted bioaugmentation according to claim 9 further including the steps of creating a fluid flow pattern within said wastewater holding treatment site and dispersing said microbial solution occur for a predetermined time period.

15. The method of accelerating volatile solids reduction and decreasing the total volatile solids volume within a wastewater holding treatment site using mixer assisted bioaugmentation according to claim 9 wherein said microbial solution includes facultative, symbiotic, spore-forming, naturally-occurring, non-pathogenic bacteria that play a role in wastewater processing.

16. The method of accelerating volatile solids reduction and decreasing the total volatile solids volume within a wastewater holding treatment site using mixer assisted bioaugmentation according to claim 9 wherein said wastewater holding treatment site is a lagoon or pond.
